(19) United States
(12) Patent Application Publication
(10) Pub. No.: US 2005/0219054 A1
(43) Pub. Date: Oct. 6, 2005

(54) Ream wrap with tracking device

(76) Inventor: Michael R. Nowak, Hilbert, WI (US)

Correspondence Address: WEISS & WEISS, Suite 251, 300 Old Country Road, Mineola, NY, 11501, US

(21) Appl. No.: 11/087,043

(22) Filed: Mar. 22, 2005

Related U.S. Application Data
(60) Provisional application No. 60/555,539, filed on Mar. 23, 2004.

(51) Int. Cl. G08B 13/14

(52) U.S. Cl. 340/572.8; 340/5.92; 235/385

(57) ABSTRACT

Wrapped reams of copier, printer, or computer paper with a radio frequency tracking device, computer chip, or some other inventory, shipping, and or storage tracking device included within or on the outside of the packaged ream.

### RELATED APPLICATIONS

The present application claims priority to provisional patent application Ser. No. 60/555,539 filed Mar. 23, 2004.

### FIELD OF THE INVENTION

The present invention relates to wrapped reams of copier, printer, or computer paper with a radio frequency tracking device, computer chip, or some other inventory, shipping, and or storage tracking device included within or on the outside of the packaged ream.

### BACKGROUND OF THE INVENTION

Reams (i.e., 500 sheets) of cut paper (8½×11, etc.) for copy machines, computers, printers, and other home and office applications are most commonly packaged for shipping, storage, and retail sale in ream wrap made of various wrap materials, including coated papers, solid plastic films, and paper/film combinations. As more people have acquired home computers and printers or started up home offices or businesses, the use of copier and printer paper by individual consumers has increased. Individual consumers typically purchase wrapped reams of paper at an office supply store, retail store, or through an office supply catalog. Reams of copier and printer papers otherwise traditionally are purchased by offices, businesses, public institutions, and other entities in larger boxed quantities. However, the proliferation of home and small offices and general home use for reamed papers has led to a dramatic increase in the demand for individually wrapped reams of paper to be stocked and inventoried by office supply stores, retail stores, and catalog companies. Because the market for individual reams of paper is growing exponentially, an inventory tracking method is highly desirable, particularly for the larger retail stores and office supply stores that stock and sell large quantities of individual reams.

### SUMMARY OF THE INVENTION

The present invention relates to a ream wrapper comprising one or more inventory tracking devices, such as a radio frequency tracking chip, computer chip, or other tracking device that is included either inside or outside the wrapped ream. It is an object of the present invention to enable sellers of individual reams to track inventory as it is shipped, stored, stocked on the shelves, sold to customers, and otherwise moved through the materials handling/warehousing/purchasing processes. It is a further object of the present invention to enable sellers of individual reams of paper to track sales of individual reams and instantly replace inventory and implement re-ordering and/or purchasing functions to replace sold inventory. It is also an object of the present invention to replace or supplement any current bar-coding systems or other tracking systems in use by retail sellers of individual reams of paper.

The present invention relates to a ream wrapper comprising one or more inventory tracking devices, such as a radio frequency tracking chip, computer chip, or other tracking device that is inserted inside the ream wrap packaging along with the cut paper.

The present invention relates to a ream wrapper comprising one or more inventory tracking devices, such as a radio frequency tracking chip, computer chip, or other tracking device that is applied to the inside or outside of the ream wrapper using glue or other adhesive material.

The present invention relates to a ream wrapper comprising one or more inventory tracking devices, such as a radio frequency tracking chip, computer chip, or other tracking device that is applied to the inside or outside of the ream wrapper using a pressure sensitive application.

The present invention also relates to a ream wrapper comprising one or more inventory tracking devices, such as a radio frequency tracking chip, computer chip, or other tracking device that is printed onto the inside or outside of the ream wrapper. The tracking device may also be coated with varnish or other materials.

The present invention also relates to a ream wrapper comprising one or more inventory tracking devices, such as a radio frequency tracking chip, computer chip, or other tracking device that is stamped onto either side of the ream wrapper during the manufacturing or printing process and which may or may be not coated with varnish or other materials.

The present invention relates to a ream wrapper comprising one or more inventory tracking devices, such as a radio frequency tracking chip, computer chip, or other tracking device or system that is used in lieu of or in addition to any bar-coding or other inventory tracking system.

It is an object of the present invention for retail sellers to track their inventories of reamed papers through the purchasing, materials handling, selling, restocking and general inventorying processes. It is a further object of the present invention to enable retail sellers to efficiently and accurately manage their inventories of reamed papers through a tracking device or system. It is a further object to enable retail sellers to replace or supplement current bar-coding or other inventory tracking systems or devices.

### BRIEF DESCRIPTION OF THE DRAWINGS

FIG. 1 illustrates an embodiment of the present invention showing a transmitter receiving information from a tracking device.

FIG. 2 illustrates a ream of paper having a tracking device underneath the ream wrapper.

FIG. 3 illustrates an embodiment wherein the tracking device is placed inside the ream wrapper by an adhesive

FIG. 4 illustrates an embodiment wherein the tracking device is stamped into the ream wrap.

FIG. 5 illustrates an embodiment wherein the tracking device is applied with a pressure sensitive device.

FIG. 6 illustrates an embodiment wherein the tracking device is placed beside a bar code on the outside of the ream wrap.

FIG. 7 illustrates a chart showing how the tracking device and the transmitter work.

### DETAILED DESCRIPTION OF THE INVENTION

In one embodiment of the present invention, an inventory tracking device, such as a radio frequency tracking chip, computer chip, or other tracking device or system is inserted inside the ream wrap packaging during the wrapping process. Thus, the tracking device is inside the package with the cut paper. This is the preferred embodiment.

In another embodiment of the present invention, the inventory tracking device or system is glued or adhered using some other material to the inside or the outside of the ream wrap packaging either during the wrapping process or during the manufacturing of the ream wrap itself.

In yet another embodiment, the inventory tracking device or system is applied to the ream wrap through a printing or stamping process during the manufacturing of the ream wrap or the wrapping of the package. The tracking device may or may not be coated with a protective varnish or other material after the stamping or printing process.

In another embodiment, the inventory tracking device or system is applied to the inside or outside of the ream wrap package using a pressure sensitive application either during the wrapping or manufacturing process.

In another embodiment of the present invention, the inventory tracking device or system is used in lieu of or in addition to a bar-coding or other inventory tracking device or system.

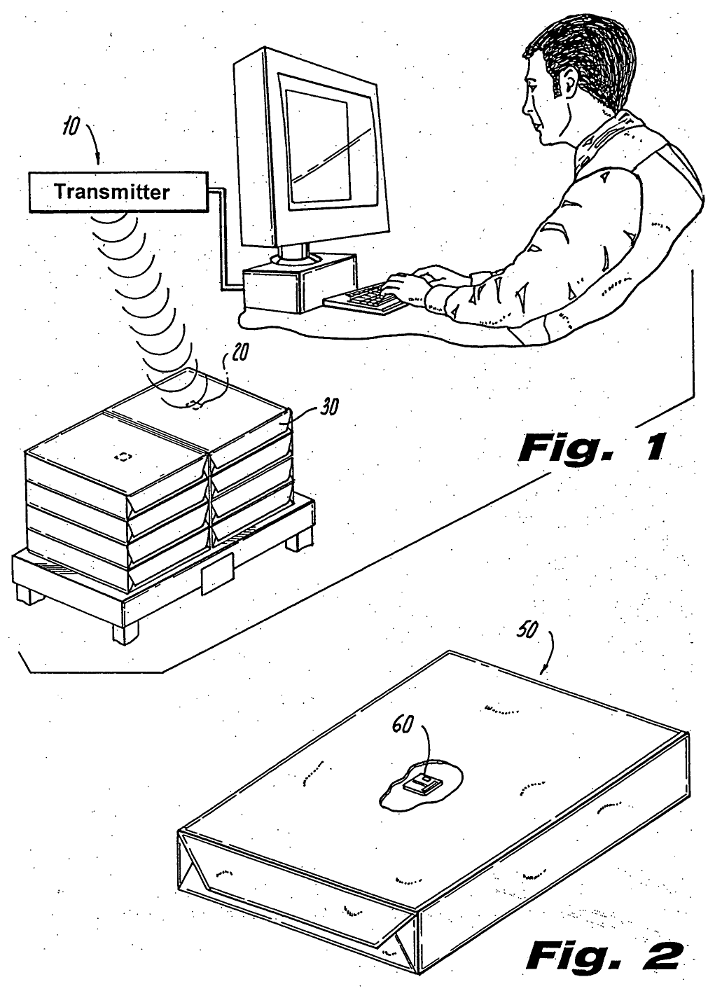

FIG. 1 illustrates an embodiment of the present invention showing a transmitter 10 receiving information from a tracking device 20 which has been placed inside a ream wrapper 30.

FIG. 2 illustrates a ream wrapper 50 having a tracking device 60 underneath the ream wrapper 50.

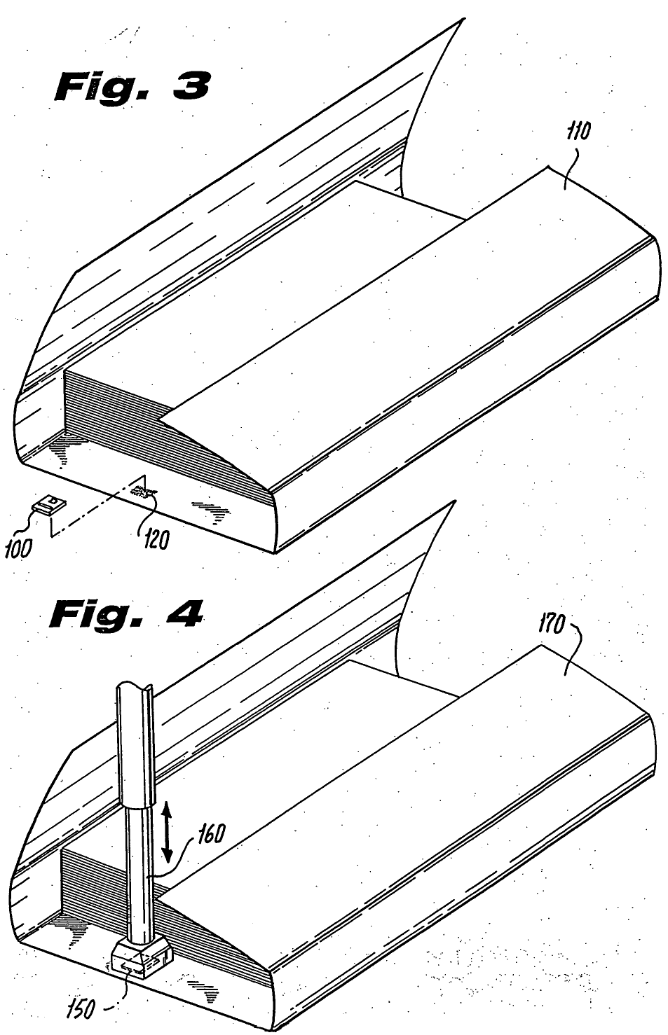

FIG. 3 illustrates an embodiment wherein the tracking device 100 is placed inside the ream wrapper 110 by an adhesive 120.

FIG. 4 illustrates an embodiment wherein the tracking device 150 is stamped or printed with device 160 into the ream wrap 170.

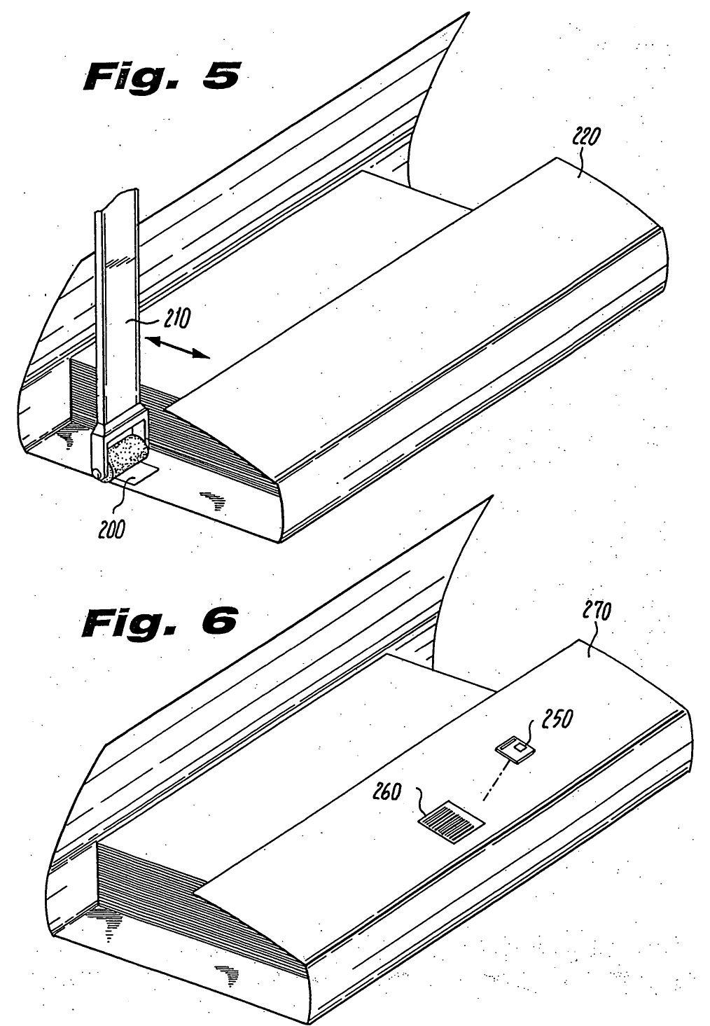

FIG. 5 illustrates an embodiment wherein the tracking device 200 is applied with a pressure sensitive device 210 into the ream wrap 220.

FIG. 6 illustrates an embodiment wherein the tracking device 250 is placed beside a bar code 260 on the outside of the ream wrap 270.

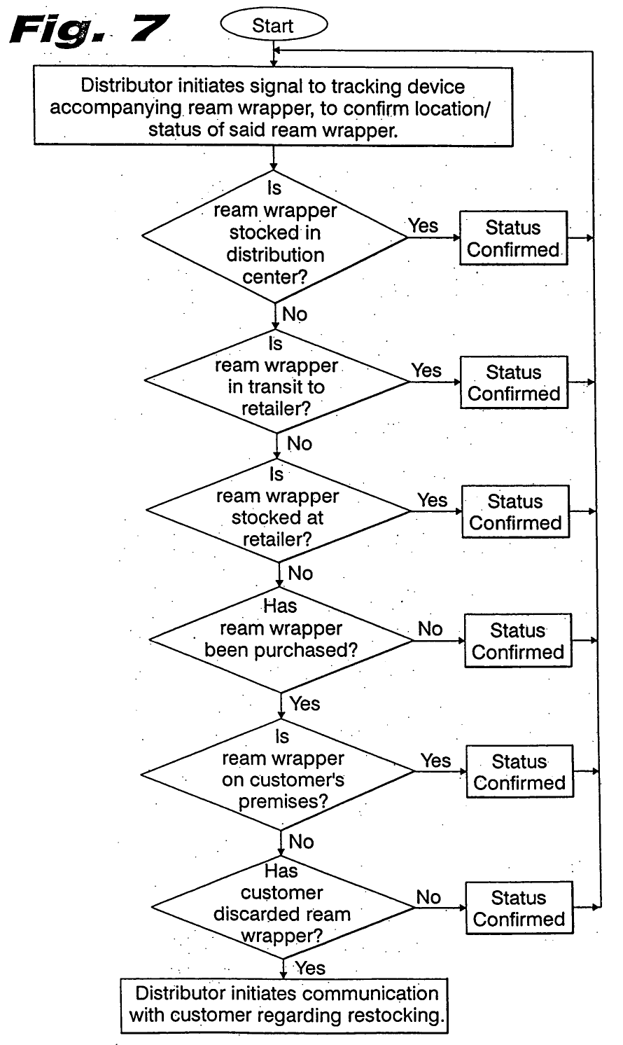

FIG. 7 illustrates one method illustrating a chart showing how the tracking device and the transmitter work. The system of the present invention initiates a signal to the tracking device accompanying the ream wrapper to confirm the location and/or status of the ream wrapper.

In a preferred embodiment, the system confirms the following:

Is the ream wrapper stocked in the distribution center.

Is the ream wrapper in transit to the retailer.

Is the ream wrapper stocked at the retailer.

Has the ream wrapper been purchased.

Is the ream wrapper on customer's premises.

Has the customer discarded the ream wrapper.

The distributor can then initiate communications with the customer regarding restocking of the paper.

1. A ream wrapper having a tracking device attached to said ream wrapper.

2. The ream wrapper of claim 1 wherein said tracking device comprises a radio frequency tracking chip, a computer chip, or other inventory tracking device or system.

3. The ream wrapper of claim 1 wherein said tracking device is inserted inside said ream wrap packaging with cut paper.

4. The ream wrapper of claim 1 wherein said tracking device is placed on the outside of said ream wrap packaging.

5. The ream wrapper of claim 1 wherein said tracking device is attached to said ream wrapper during a wrapping process.

6. The ream wrapper of claim 1 wherein said tracking device is attached to said ream wrapper during manufacturing of said ream wrap.

7. The ream wrapper of claim 1 wherein said tracking device is adhered to either the outside or inside of said ream wrap packaging using adhesive materials or glue.

8. The ream wrapper of claim 1 wherein said tracking device is printed or stamped onto an inside or outside of said ream wrap packaging.

9. The ream wrapper of claim 1 wherein said tracking device is coated with varnish or other protective material.

10. The ream wrapper of claim 1 wherein said tracking device is applied to an inside or outside of said ream wrap packaging using a pressure-sensitive application.

11. The ream wrapper of claim 1 wherein said tracking device is used in lieu of or in addition to a bar-coding or other inventory tracking system or device.

12. The ream wrapper of claim 1 wherein said tracking device is used to track stocking, shipping, materials handling, location, selling, transport, purchase, and inventorying functions associated with sale of individual reams of cut paper.

13. A method for tracking a ream of paper comprising:
initiating a signal to a tracking device attached to a ream wrapper;
confirming location and/or status of said ream wrapper.

14. The method of claim 13 further comprising:
initiating communications with a customer regarding restocking of paper.
